(19) United States
(12) Patent Application Publication
(10) Pub. No.: US 2026/0213851 A1
(43) Pub. Date: Jul. 23, 2026

(54) PROCESS FOR EXCHANGING DATA/INFORMATION USING SINE WAVES

(71) Applicants: Emanuele COSTANZO, Aci Catena (CT) (IT); Ciro POLESE, Sant'Antonio Abate (NA) (IT); Renato COSTANZO, CATANIA (IT); Gianfranco COSTANZO, CATANIA (IT); Andrea COSTANZO, CATANIA (IT); Fabio COSTANZO, CATANIA (IT); Gabriele COSTANZO, CATANIA (IT)

(72) Inventor: Emanuele COSTANZO, ACI CATENA (CT) (IT)

(73) Assignees: Emanuele COSTANZO, Aci Catena (CT) (IT); Ciro POLESE, Sant'Antonio Abate (NA) (IT); Renato COSTANZO, CATANIA (IT); Gianfranco COSTANZO, CATANIA (IT); Andrea COSTANZO, CATANIA (IT); Fabio COSTANZO, CATANIA (IT); Gabriele COSTANZO, CATANIA (IT)

(21) Appl. No.: 19/138,833

(22) PCT Filed: Dec. 6, 2023
(86) PCT No.: PCT/IT2023/050273

§ 371 Date: Jun. 13, 2025

(30) Foreign Application Priority Data
Dec. 14, 2022 (IT) 102022000025623

(51) Int. Cl. H04B 10/516; H04L 27/04

(52) U.S. Cl. CPC H04B 10/516; H04L 27/04

(57) ABSTRACT

A process for exchanging data/information using sine waves is described, the process comprising the steps of: transmitting and receiving data using a coded sine wave; wherein coding includes the sub-steps of: creating a work environment; adopting a numerical system with a higher base than base 2 of the binary code; defining and classifying the symbols of the adopted number system using a symbol classification method; generating geometric waveforms via mathematical functions; varying, moment by moment, the amplitude of each sine wave; through variations in amplitude, forming points; creating an array where each symbol is associated with a corresponding numerical value; and using the array as a type constructor.

### TECHNICAL FIELD

The present invention refers to a process for exchanging data/information using sine waves.

The following description will refer, in general, to sine waves, but the invention equally applies to their components, such as amplitude, frequency, phase, etc.

### BACKGROUND ART

The basic principle of the technology in question consists of a new method of data transmission through the processing of electrical impulses and coded signals, composed of one or more sine waves, such as sound waves, electromagnetic waves (radio, infrared, light waves, etc.), of oscillatory electrical signals or other similar waves, even combined together in algebraic spaces, in the space of fractions of a second of time, applying properties, mathematical functions, complex numbers, which in the mathematical analysis phase define the fundamental elements, such as: identity, shapes, angles, distances, orthogonality, norms, etc. This technology allows data to be compressed, stored, encrypted and communicated, as well as to convert information from one form to another, to encode networks and to remotely transport information between users through wireless communication signals.

### DESCRIPTION OF THE INVENTION

The present invention also represents a technological tool for wireless data transmission through sound waves. This technology represents an economical and safe method for exchanging information between different devices through the use of one or more sound waves with different frequencies. The transmission range of data generated by this type of communication is subject to the amplitude, type of frequency and reception capacity of the instruments used, generated by the transmitting and receiving sources, putting them in communication with each other.

There are no known processes in the art that process one or more sound waves, even combined with each other, to create a signal containing the entire information to be transmitted.

Document CN-B-106 487 454 describes an earlier method for configuring sine waves. This method is based on a formula that is incompatible with the present invention, involving a phase change and generating results that fail to achieve the objectives of the present invention. In the method of CN-B-106 487 454, sound waves are used to transmit information by converting data into distinct sound frequencies. In the previous method, each character is represented by a specific frequency and a certain number of sampling cycles. The present invention, on the other hand, takes an innovative approach, using a sine function A.sin(2π ft) where “A” indicates the amplitude of the wave. By modulating this amplitude to represent different information, it is possible to vary the amplitude to encode multiple symbols on the same frequency in one second. This technique offers greater flexibility, allowing the transmission of a wide range of information and making it possible to use it in customized and specific applications. Furthermore, in the wave recognition step, advanced analysis systems are implemented. These systems guarantee greater reliability in recognizing the information transmitted. Due to these innovations, the present invention overcomes the limitations of the method described in document CN-B-106 487 454, providing more effective and versatile solutions for data transmission via sound waves.

The process of the present invention, as previously described, makes the most of standard audio components such as speakers and microphones, already integrated into numerous communication devices available on the market. This approach eliminates the need to implement additional hardware components, aligning with current technical-industrial standards for short-and long-range data transmission. Current standards are primarily based on the use of digital signals through Radio-Frequency, RF waves, which are essential in various industries, including construction and others that require specific devices for transmission and reception. The present invention is distinguished by the integration of piezoelectric transducers, advanced microphones, hydrophones and sophisticated RF systems. Piezoelectric transducers enable the conversion of mechanical pressures into electrical signals and vice versa, offering new possibilities for transmitting and receiving data in different environments, including underwater or high-pressure environments. The use of hydrophones, specialized in detecting sounds underwater, opens the way to new applications in marine environments, improving communication and data collection in such contexts.

Furthermore, the use of RF systems further expands the capabilities of the present invention, allowing efficient and reliable data transmissions even over long distances. The combination of these advanced technologies with standard audio systems significantly extends the scope of the present invention, making it suitable for a wide variety of scenarios, both terrestrial and aquatic, and overcoming the limitations of traditional data transmission methodologies.

The invention can be achieved in nature: in particular, sound propagation is ideal both for underground environments where there is not a sufficient number of radio wave repeaters, and for aquatic environments, because water is less compressible than air and therefore the vibration is transmitted more rapidly (approximately, the speed of sound in water is equal to 1500 m/s), unlike radio waves which are instead absorbed by water, which acts as their conductor.

In order to guarantee the exchange of information via radio or infrared frequencies, as required by the current known or knowable state of technology, the manufacturers of smartphones, tablets, smartwatches, computers, etc. must necessarily provide that their devices are equipped with additional hardware components, not necessarily supplied as standard, such as infrared technology, Bluetooth or Wi-Fi.

The primary object of the present invention is overcoming the limitations of previous technologies, introducing a revolutionary method for exchanging data and information through the use of sound waves. This innovative approach lends itself to a wide and varied range of applications in numerous sectors, demonstrating extreme versatility. Between these:
Agriculture and Livestock: for advanced monitoring and optimized management of resources;
Mechanics and Engineering: for precision control of machinery and preventive maintenance;
Safety and Emergency Management: essential in critical contexts such as avalanches or earthquakes, where conventional communications can fail;
Medical Diagnostics and Healthcare Industry: from use in imaging devices to advanced surgical instruments, as well as patient monitoring systems;
Industrial Sector: applications in measuring instruments, optical readers, and payment systems;
Underwater Environments: effective use in underwater communications, where sound waves are particularly efficient;
Telecommunications and IT: improving data transmission in high-density and interference environments;
Transport and Automotive: integration into navigation and safety systems for land, sea and air vehicles.

The distinctive feature of the present invention is its ability to operate on frequencies different from those used by conventional communication tools, such as radio waves, thus avoiding any interference. This allows for fluid and non-invasive integration into existing systems, making the technology suitable for a very wide range of application scenarios, both conventional and innovative, significantly extending the field of use of sound waves in data transmission.

The above and other objects and advantages of the invention, as will appear from the following description, are achieved with a process for exchanging data/information using sine waves as claimed in claim 1. Preferred embodiments and non-trivial variations of the present invention form the subject matter of the dependent claims.

It is understood that all attached claims form an integral part of this description.

### BRIEF DESCRIPTION OF THE DRAWINGS

The present invention will be better described by some preferred embodiments, provided by way of example and not by way of limitation, with reference to the attached drawings, in which:

FIG. 1 shows a block diagram of an application example of the present invention;

FIG. 2 shows a process for generating a signal with symbolic modulation;

FIG. 3 shows an image representing a graph in two dimensions;

FIG. 4 shows the continuation of the concept represented in FIG. 3, providing further detail on the data coding method; and

FIG. 5 shows the decoding process of a coded signal.

### EMBODIMENTS THE INVENTION

A preferred embodiment of the present invention will be described below. It will be immediately obvious that numerous variations and modifications can be made to what is described (for example relating to shape, dimensions and parts with equivalent functionality) without departing from the scope of the invention as appears from the attached claims.

Some of the transmission and reception tools used for exchanging data through the process of the invention can be, by way of example: computers, PDAS, mobile phones, personal computers, laptops, digital cameras, smartwatches, video game consoles, televisions, acoustic modems, headphones and any other device capable of emitting and/or receiving frequencies, usually already equipped with hardware specifications and which can subsequently adopt a specific software to exploit the potential of the technology in question.

In addition, the applicability also extends to devices that use Radio Frequency, RF technologies, such as antennas, satellite receivers, GPS devices, and wireless communication systems.

Other tools include Internet of Things, IOT devices, environmental sensors, security and surveillance systems, medical equipment such as ultrasound, and underwater devices such as sonars and hydrophones.

The flexibility of the present invention allows its adaptation to a wide range of devices and systems, significantly expanding its applications in the field of data transmission and reception.

In general, the process for exchanging data/information according to the present invention uses sine waves, specifically, all the possible frequencies of sound waves, of the electromagnetic spectrum (radio, light, infrared waves, etc.) and so on, as well as their components (amplitude, period, phase, etc.). This process includes the steps of:
transmitting data using multiple coded sine waves or even just one of these, such as sound waves, electromagnetic spectrum waves, etc.;
receiving data using at least one coded sine wave;
   wherein the coding of each of the sine waves includes the sub-steps of:
creating a work environment, including the sub-steps of:
   a. choosing an operating system suitable for project development, for example Windows, macOS or Linux;
   b. installing programming software suitable for the type of project that has to be developed, for example Python, Java, C++, etc.;
   c. installing any libraries or frameworks needed for the project;
   d. creating an organized folder and file structure to store project files;
adopting a numerical system with a higher base than base 2 of the binary code; considering that the best Institute of Electrical and Electronic Engineers, IEEE standards are able to reach data transmission speeds of up to over Gigabits per second, using binary sequence signal transmissions, it is possible to accelerate the aforementioned transmission speed even further by using signals that adopt positional numbering systems with a base greater than base 2 of the binary code (currently the most used by most electronic devices), therefore representing a multi-symbol code which for convenience will generally be called Greater Base Object Code
defining and classifying the symbols of the numerical system adopted; a method of classification of the symbols used for the adopted numerical system is chosen, which takes into account the characteristic elements of sine waves, i.e., amplitude, radiant frequency, phase angle, identity, shape, distance, orthogonality, norm, etc.; by way of example and not exhaustively, it is possible to identify the individual symbols through precise geometric shapes or through the different heights of the same geometric shape and so on. In particular, it has been chosen to identify the symbols of the numerical system that has to be adopted, applying specific mathematical functions that allow each single sine wave to represent a sequence of distinct shapes, to each of which is assigned a unique symbol corresponding in turn to a certain value of the chosen numerical system, or for example, in an ideal development environment, i.e., without interference, disturbances, etc.; it is also possible to exploit the amplitude of each single sine wave used, in order to identify the individual symbols through the different variations of the same, that is, for each variation in amplitude of the sine wave, it is possible to assign a unique symbol corresponding in turn to a certain value of the chosen numerical system;
compiling the source code; in order to prepare pre-existing multimedia files (text files, musical pieces, images, videos, etc.) to be able to transmit them from a transmitting electronic device (transmitter) to a receiving electronic device (receiver) using the technology in question, the source code of the aforementioned files are translated by a special program (compiler) into a sequence of symbols belonging to the chosen numerical system;
generating geometric waveforms using mathematical functions;
varying, moment by moment, the amplitude of each sine wave within a Cartesian plane, in which time is located on the abscissa axis and the amplitude of the sine wave is located on the ordinate axis, thus describing the uniform rectilinear motion of the wave amplitude as time varies;
   The data transmission process described in the present invention exploits amplitude variations to generate a temporal sequence of distinct points. These points, according to criteria predefined by one or more functions, are connected through an imaginary line that traces Coded Geometric Models (MGC), each of which represents a unique symbol in the adopted numerical system. The temporal succession of these geometric patterns generates signals that are easily identifiable during reception as encoded signals. The modulation mechanism is formulated by the equation

MGC×sin(2π ft)

where MGC represents the Coded Geometric Models, each associated with a specific data or value. The sine function sin(2π ft) describes a periodic wave, where 2π converts frequency and time to angular phase, t represents the time determining position within the wave, and f is the frequency of the sine wave.

Modulation of an MGC with a sine wave at a specific frequency generates a sound signal that can be transmitted and can subsequently be decoded in order to recover the original data.

In particular, in the case of using a single frequency to create the signal, the amplitude A of the sine wave is used to represent a specific geometric shape over a period of time, the formula of the sine wave being given by:

A·sin(2π ft)

where:
A is the amplitude, which corresponds to the geometric shape to be represented over time;
f is the frequency of the sine wave;
t is the time.

However, the present invention goes beyond this methodology, making use of the contextual use of multiple frequencies, each with a specific value, which trace the same geometric shape. This multi-faceted approach is designed to improve signal robustness and optimize transmission distance.

In detail, while the modulation of a single frequency event might be sufficient to outline the desired shape, the introduction of several frequencies of variable amplitude allows the signal to be marked and strengthened. Using multiple frequencies adds a dimension of complexity to the transmitted signal, making it more recognizable and resilient to interference when received. The simultaneous variation of the amplitudes of the different frequencies helps creating a more distinctive and easily interpretable signal by the receiving device. The diversity of the frequencies used also allows the range of the signal to be increased, allowing for more effective transmission even at greater distances. This feature is crucial to ensure the reliable transmission of information, especially in contexts where coverage and signal quality may be variable. Ultimately, the use of multiple frequencies of different values tracing the same geometric shape represents a key optimization of the signal modulation technique, helping to ensure a more robust, recognizable and reliable data transmission.

Controlled modulation of the amplitude A is crucial for tracing precise geometric shapes. This process involves creating a series of “maximums of a time piecewise function”, where each maximum represents a key point of the desired geometric shape. If these points are connected to each other by an imaginary line, they outline the profile of the desired geometric shape.

These maximum points are generated in temporal succession, according to pre-established criteria, allowing the geometric shapes to be traced precisely. This sequence of maxima, which correspond to the vertices or salient points of the geometric shapes, is determined by the trend of the wave amplitude over time.

Once created, geometric shapes can be combined together to generate complex and unique signals. These signals, once received and analysed, allow the encoded information to be efficiently decoded. The system exploits the amplitude modulation of sine waves to represent and transmit information in a unique and identifiable way, using geometric shapes as a means of coding.

While the system described above uses a single frequency to encode information using the modulated amplitude of a sine wave, it is also possible to extend this process to incorporate multiple frequencies. This extension allows for greater complexity and versatility in data encoding.

To guarantee the integrity and precision of the signals containing the Coded Geometric Models, MGC, developed by this method, the use of a band-pass filter has been implemented in particular. This preventative solution can be important to ensure that the MGC signals remain confined within the chosen frequency band, preventing the encoded geometric shapes from exceeding the established frequency limits. The band-pass filter is carefully selected to limit the frequency range within which MGC signals are transmitted, excluding any frequencies outside this range. This stringent control effectively prevents interference or distortion, keeping MGC signals within the desired boundaries. In particular, this measure ensures the purity and effectiveness of signals in data transmission, safeguarding their quality and reliability.

The inventive process includes the further steps of:
classifying the symbols used for the numerical system that have to be adopted using a method that takes into account the characteristic elements of sine waves, in particular amplitude, radiant frequency, phase angle, identity, shape, distance, orthogonality, norm, etc. In particular, it is possible to identify the individual symbols through precise geometric shapes or through the different heights of the same geometric shape and so on. In particular, it has been chosen to identify the symbols of the chosen numerical system by applying specific mathematical functions that allow each individual sine wave to represent a sequence of distinct shapes, to each of which is assigned a unique symbol corresponding in turn to a specific value of the chosen numerical system, or for example, in an ideal development environment, i.e., without interference, disturbances, etc.. it is also possible to exploit the amplitude of each single event of the sine wave used, in order to identify the individual symbols through the different variations thereof, that is, for each variation in the amplitude of a single event of the sine wave, it is possible to assign a unique symbol corresponding in turn to a specific value of the numerical system with a base greater than the chosen base 2;
creating an array where each symbol is associated with a corresponding numerical value from 0 to n, where n represents, in numerical sequence, the largest value of the array, corresponding in turn to the basis of the numerical system that has to be adopted, for example n=2 for a binary system or n=16 for a hexadecimal system;
using the array as a type constructor, in order to allow the definition of new data types starting from pre-existing symbols, in which the combination of the symbols of the array allows the information to be transmitted to be communicated;
optionally encoding the information to be communicated, for example using Javascript Object Notation, JSON;
optionally, encrypting the information to be communicated.

The inventive process also allows the creation of a signal also composed of the combination of several frequencies.

In order to increase the information transmission capacity, the technology in question can use single frequencies, even combined with each other, for the transmission of the same signal containing all information to be transmitted.

Each single sine wave, processed according to the processes and methods/techniques of the technology in question, in addition to being able to represent on its own the entire information to be transmitted, can be simultaneously combined with other similar sine waves but with different frequency, even simultaneously, thus contributing to the formation of even more complex coded signals and with greater information transmission capacity (the more sine waves with different frequencies are used to form the same signal, the greater the quantity of data that the latter is capable of transmitting).

As regards the transmission of the coded signal, as a pure application example, in case of an audio signal, common acoustic speakers can be used which transform the electrical signal into sound such as, for example, the speakers of the audio speakers, while, in the case of a radio signal, electrical devices capable of transmitting electromagnetic waves can be used, such as the antennas used in telecommunications.

The inventive process further comprises the step of analysing the received signal. This step, in turn, can include the sub-steps of:
transforming the signal from continuous signal to discrete signal; for the analysis of a continuous signal received in input, a quantization and conversion technique is used, capable of approximating the continuous signal in a digital string (discrete in time and amplitude); in particular, the sampling, in order to convert the signal from continuous in time or space into a discrete signal, evaluating its amplitude at temporal or spatial intervals; in particular, due also to the Fourier Transform, a mathematical operator that allows decomposing a function that varies over time in a discrete set of complex amplitudes at regular time intervals (Fourier series coefficients), represented in the frequency domain (spectrum of the function). Sampling therefore allows digitizing a signal without reducing its information content;
analysing a signal in the input step; sampling therefore consists of measuring and recording the value of the analogue signal at different time instants. In order to establish what the minimum sampling frequency is so that the analogue signal can be reconstructed starting from the discrete input signal, in particular, the Shannon-Nyquist sampling theorem is implemented;
applying a passive filter; in particular, applying an electronic filter, that is, a system or device that carries out transformation or processing functions (signal processing) of signals placed at its input. The function of the filter is to eliminate certain frequency bands, letting all the others pass. In particular, a band-pass filter is applied, a passive device that allows the passage of sine waves that have a frequency that falls within a given frequency range (the so-called band-pass) and attenuates frequencies outside of it.

The inventive method further includes, when multiple sine waves with different frequencies are used, the step of sequencing such sine waves.

This step of sine wave sequencing can include the sub-step of choosing the process for determining the exact sequence of the code to be transmitted, namely the order of the symbols used to represent the signal containing the information to be communicated. In particular, succession on a time scale is used, so that the time line represents, in chronological order, the succession of a series of symbols representing the data to be transferred.

In particular, the affected sine waves may be sound waves, in particular from 0 to 200 MHz or more.

Alternatively, the frequencies involved may be radio frequencies, in particular from 3 to 3000 GHZ.

As indicated above, the basic principle is to build and process signals composed of one or more sine waves (sound waves, radio waves, infrared etc.) even combined with each other, within a fraction or more fractions of a second of time. Therefore, those who want to adopt this technology will be able to choose whether to adopt a binary system, a decimal system, a hexadecimal system, etc. Preferably, the step of creating a work environment includes the following sub-phases:
choosing a programming language, where such programming language is high-level, object-oriented, to be adopted for application development, scripting, numerical computations and system testing;
creating a library, wherein, through the chosen programming language, a computer library of high-level mathematical functions and data structures is
created, to be able to operate efficiently with the mathematical algorithms for the sources that produce signals, with analysis, modelling, coding and decoding of the same;
coding the information to be communicated, wherein the information to be communicated is, in turn, encoded in a text format independent of the chosen programming language. In particular, it has been chosen to code in JavaScript Object Notation, JSON format, which is easy to read and write for people, and equally easy to generate and analyse the syntax for machines; in fact, the JSON format, despite being based on a subset of the JavaScript programming language, uses conventions known by programmers of languages of the C family, such as C, C++, C#, Java, JavaScript, Perl, Python and many others, a feature that makes JSON an ideal format for data exchange;
encrypting the JSON content of the information to be communicated, wherein, in order to make the information to be transmitted semantically unreadable, namely not comprehensible/intelligible to unauthorized persons, the JSON content of the information to be communicated is encrypted through a series of well-defined steps, performed as a procedure, based on an algorithm and a cryptographic key (Encryption Technique), thus returning a new encrypted code which will be called Cryptogram.

The Cryptogram therefore contains all information in clear text of the JSON content of the information to be communicated, but expressed in a format unreadable by humans or computers without a specific deciphering algorithm: to those who are not able to read it, it appears as a sequence of meaningless characters. In this way, the confidentiality and privacy of information are guaranteed, essential requirements in the field of IT security, thus preventing the implementation of various types of cyber-attacks on confidential data (for example, sniffing).

The operation carried out by the encryption technique depends on auxiliary information that influences the encryption process, that is, the cryptographic key which, used as a parameter of the cryptographic algorithm, must be chosen before encrypting the message and without its knowledge, makes it difficult, if not impossible, to decipher the Cryptogram, both knowing and not knowing the algorithm underlying the encryption technique.

The cryptographic key is therefore an alphanumeric string that implements the coding/decoding algorithm of protected information, and its size, generally measured in bits, depends on the particular algorithm used for the encryption technique. The algorithms adopted can use keys of different lengths and in this case the longer the key, the more difficult it will be to force the encrypted message;
sequencing the code to be transmitted, wherein, using Coded Signals to represent the information to be transmitted, composed of the symbols of the chosen numerical system, it is guaranteed that, during their creation and analysis, it is possible to determine the exact sequence of the code to transmit. In this regard, the process is chosen for determining the exact sequence of the code to be transmitted, namely the order of the symbols used to represent the Coded Signal containing information to be communicated. In particular, succession on a time scale is used, so that the time line represents, in chronological order, the succession of the series of symbols, representing the data to be transferred;
chaining multiple sine waves with different frequencies that form a single information to be transmitted.

Since the invention in question also makes use of the aid of multiple sine waves with different frequencies for the creation of a single information to be communicated, which from now on will be called “Transmission Waves”, in order to also determine in this eventuality the exact sequence of the code to be transmitted, a process is chosen that returns a sequential order, in addition to the symbols used in the individual sine waves, also to the different Transmission Waves, in particular, the latter will be ordered based on the value of their frequencies, that is, they are linked together according to a sequential positioning based on an ascending order relationship of their frequencies, such that a Transmission Wave having a lower frequency precedes another Transmission Wave with a higher frequency, and so on, for how many Transmission Waves are used to form a single signal containing the entire information to be transmitted.

To create test software to test the process of the invention, capable of sending and interpreting signals composed of multiple sine waves combined together, it was decided to exploit the technical capabilities of IT development, creating software that allows multiple devices (for example personal computers, smartphones, smart TVs, etc.) to be able to be connected to each other via sound waves and exchange data.

a) The first step in creating this test software is preparing a library of high-level mathematical functions, to be able to operate efficiently with the mathematical algorithms for the sources that produce signals, analysis, modelling, coding and decoding of the same.

b) For the experiment, it was decided to exploit every single moment of time to simultaneously transfer multiple hexadecimal symbols, each of which is composed of a sound wave with a frequency between 20,000 and 23,000 Hertz, for the formation of a single audio signal encoded representation of information to be transmitted.

c) The choice of sound waves with a frequency between 20,000 and 23,000 Hertz was preferred because these frequencies are barely audible to the human ear and easily recognizable by the microphones of the most common devices currently on the market (smartphones, tablets, PCs, etc.).

d) The above example can be implemented using a virtual ultrasonic keyboard with a chat communication system.

e) Taking the ASCII coding system as a reference, which assigns a unique number to each character used for writing texts, a table has been created where precise combinations of sine waves with different frequencies are associated with the numbers in the aforementioned ASCII code table.

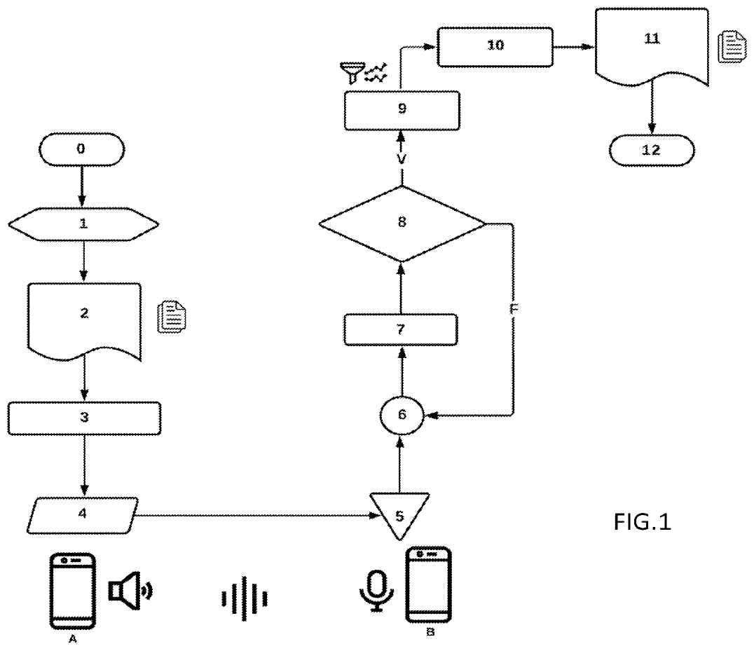

f) With reference to FIG. 1, the procedures are as follows:
0. Start
1. Creating a working environment
a. for the example, the programming language adopted is Python
b. creation of work environment
c. work environment configuration
d. the numerical system adopted is the hexadecimal one, which uses 16 symbols from 0 to 9 for the first ten digits, and then the letters from A to F for the next six digits, for a total of 16 symbols. The aforementioned symbols of the hexadecimal numerical system are represented within an array, used as a type constructor, in order to allow the definition of new data types starting from the 16 pre-existing symbols.
e. preparation of a graphical interface for the creation of a virtual chat
f. creation of a process for the creation of geometric shapes using the variation in amplitude of sine waves
g. association of each shape created with the individual symbols of the hexadecimal system adopted
h. creation of the information to be transmitted through the virtual chat with appropriate coding and encryption
2. Preparation of the information to be transmitted, for example “Hi, how are you?”
a. JSON format application e.g. {t:“Hi, how are you?”}
b. the information to be transmitted is encoded in JSON format, from now on called “JSON File”
c. encoding the JSON file in a number system
d. encoding of the JSON file into symbols of the chosen numerical system, from now on called “Coded Information”
e. encryption of the Encrypted Information, from now on referred to as “Information to be Transmitted”
f. creation of the method of representing the Information to be Transmitted through one or more sine waves combined together
g. choice of the method of sequencing the symbols of the coded signal within the sine waves 3. Sampling of the coded signal to be transmitted, that is, the amplitude of each sine wave used to create the information to be transmitted is varied at each individual sampling point
4. Sending the signal by Device A, through an audio speaker
5. Reception of the audio stream by Device B, through a microphone. The object code of the audio stream transmitted by the microphone (input) is processed through a “while loop” with “true”, applied to every fraction of a second, used to execute a block of code which has the task of putting the microphone into continuous listening and to transform the aforementioned audio stream into a series of samples (sampling).
a. creation of the method of receiving the input signal flow
b. reading the input audio stream
6-7-8. Analysis of the audio stream received from Device B
a. creation of a control structure which, for each audio stream received as input, applies the Fourier Transform to extrapolate the components of the sine waves (amplitude, frequency, phase, etc.) involved in the input stream. The Fourier Transform therefore allows you to identify every single signal described in the chosen interval and to obtain the value of the amplitude of the sine waves as time varies which, through the application of a specific function, returns an array with all the frequencies that make up each signal and their respective amplitudes. Performs the instructions described in the following points only when a specific condition occurs; in particular, the “while true” cycle is used (states F=false and V=true), from now on called “Verification Cycle”, in which the condition to be satisfied requires that the amplitude of at least one of the frequencies received must be greater than a certain value chosen during the configuration phase (from now on called “Boolean Condition”).
b. measurement of the values of the input flow components, in order to verify whether the Boolean Condition is satisfied or not
c. if the Boolean Condition is not satisfied, the Loop is repeated again until the condition is satisfied.
d. if the Boolean Condition is satisfied, in particular an electronic filter is applied, which has the task of filtering the components of each single sine wave of the received audio stream as the time varies, in particular, a band-pass filter is applied which allows filtering the value of the amplitudes of the individual sine waves as time varies. The possible use of perfectly flat band-pass filters therefore keeps the roll-off regions as narrow as possible and allows the filters to operate as much as possible as ideal filters that attenuate all frequencies outside the chosen ranges as much as possible.
9. Analysis and reconstruction of the original signal sent by the transmitter (from now on called “Original Signal”), which consists in analysing the incoming audio signal, through individual observations carried out in fractions of a second, in search of the typical signal, that is, signals characterized by the properties described previously, through the values of the amplitudes of each single sine wave as time varies.
10. Interpretation of the Original Signal
a. deciphering of the Original Signal, the result of which is henceforth referred to as the “Deciphered Signal”
b. decoding of the “Decrypted Signal”
11. Transmission of information from Device A to Device B through an audio signal
12. End

The process of the invention allows transferring simple and complex data, such as a photo or an audio track.

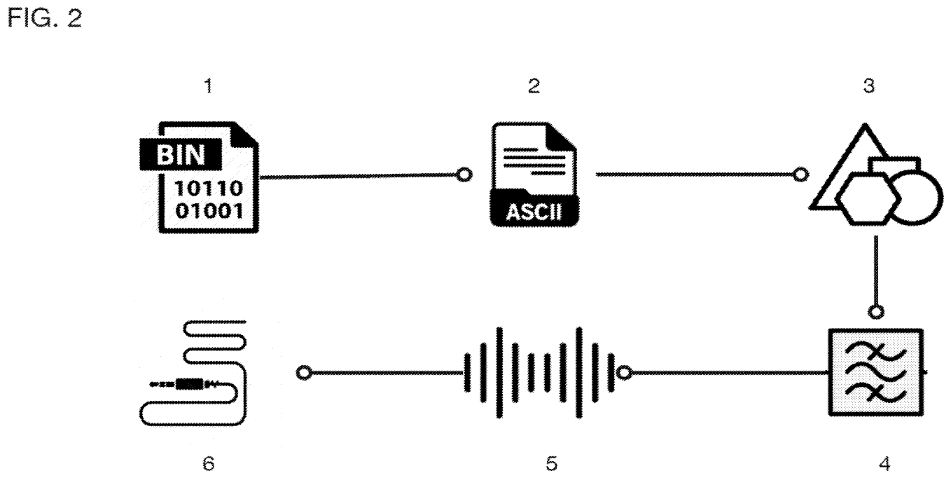

In summary, as regards the operation of the inventive process, and with reference to FIGS. 2 to 5, FIG. 2 shows a procedure for generating a signal with symbolic modulation. It describes the method for generating an encoded signal using the patented technology, following the key steps that transform the data from a binary format to a transmitted signal, on the creation of geometric shapes as a symbolic representation:
1. Binary File: The process begins with a binary file that contains the data to be transmitted.
2. Symbolic Decoding: The binary series is decoded into understandable symbols (for example, into 256 ASCII characters), which act as intermediaries between raw data and their symbolic representation.
3. Creating Geometric Shapes for Symbols: For each symbol, a unique geometric shape is generated within its dedicated frequency. These geometric shapes are the result of modulating the amplitude of the sinusoid, which varies to create shapes such as rhombuses, squares, semicircles, crosses, etc., and represent the coding of symbols within the signal.
4. Application of Band-pass Filters: Band-pass filters are applied to ensure that each geometric shape remains confined to its assigned frequency and does not overlap with the others, maintaining the integrity of the signal.
5. Signal Generation: With the application of filters, the symbolic geometric shapes are combined to form the overall signal representing the initial data sequence.
6. Signal Transmission: The finished signal is then ready to be sent via wired or wireless means to the recipient.

This detailed workflow illustrates the process of transforming data into a format that uses waveform modulation to symbolically represent the information, thus ensuring effective and secure signal transmission.

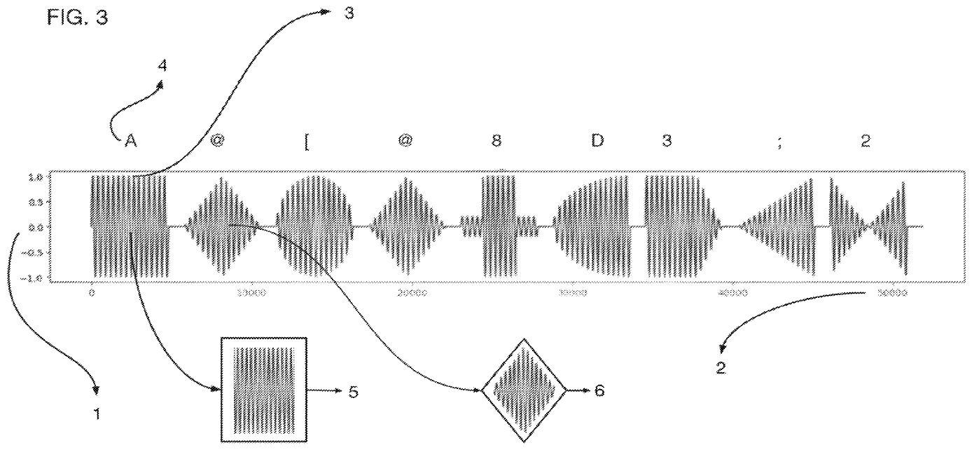

FIG. 3, to visually describe the idea, shows an image representing a graph in two dimensions.

In the graph:

1. Amplitude: The vertical axis of the graph varies between −1 and 1, representing the amplitude of the frequency.
2. Timeline: The horizontal axis of the graph shows time, measured in sample rates.
3. Sine Wave: A sine wave curve, which changes over time, moves across the graph, creating geometric shapes.
4. Symbols: These geometric shapes are created by the amplitude peaks distributed along the time line. These shapes represent numeric alpha symbols.
5. Rectangle Envelope: A figure representing a rectangle, indicating the envelope of one of the geometric shapes created by the sinusoid.
6. Rhombus Envelope: In detail, the sinusoid waveform undergoes a controlled alteration whereby, at regular intervals along the time axis, the amplitude reaches maximums and minimums which, if connected by an imaginary line, outline the shape of a rhombus/diamond. This diamond acts as the envelope for the waveform section and represents the modulation of the signal encoded with the associated symbol. The rhombus envelope is not only a visual guide but is also a key element for the interpretation and decoding of the symbol represented by the modulation of the sinusoid amplitude.

The image then shows how the mathematical function changes the frequency amplitude over time to create symbols through geometric shapes.

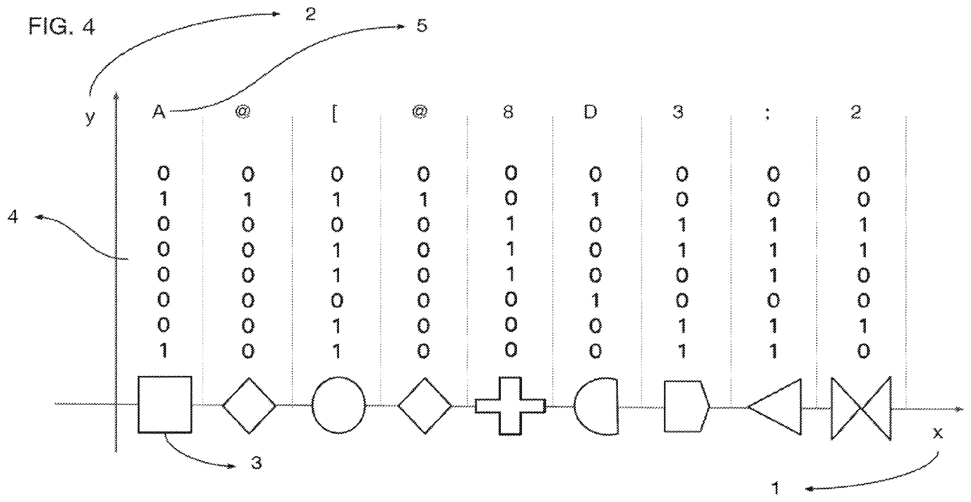

FIG. 4, however, shows the continuation of the concept represented in FIG. 3, providing further detail on the data coding method.

FIG. 4 shows the direct relationship between the sinusoid waveform modulation and its binary representation.

1. X Axis-Time: Indicated with number 1, the horizontal axis shows the passage of time.

2. Y Axis-Amplitude: Marked with number 2, the vertical axis represents the amplitude of the signal which varies from −1 to +1.

3. Symbol Envelopes: Number 3 indicates the envelope of each symbol.

4. Binary Code: Number 4 refers to a string of binary code (for example 01000001 for the 8 bit) that is positioned vertically above the envelope and represents the binary value of the encoded symbol.

5. Value of the Symbol in the Chosen System: with number 5, above each symbol is indicated its corresponding value in the chosen coding system, such as the letter ‘A’for the binary code 01000001.

This figure shows how the sine waveform is modulated to represent different symbols and how these are then decoded into a binary format, providing a visual bridge between the analogue and digital data.

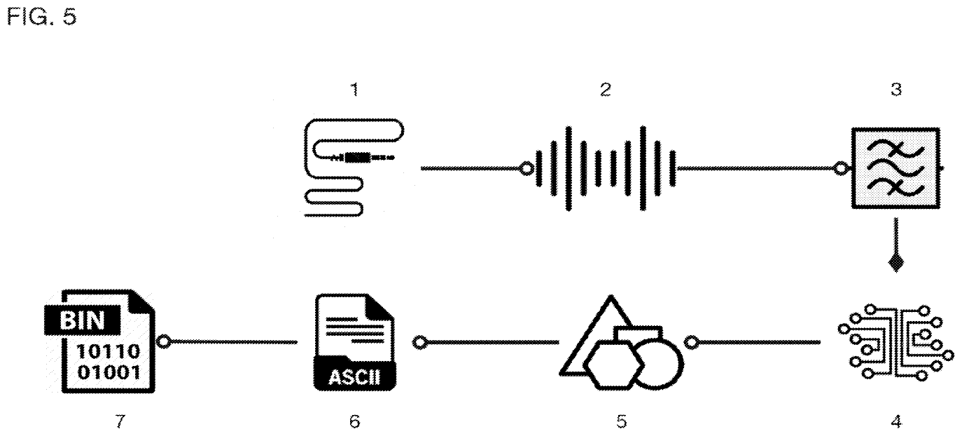

Finally, FIG. 5 shows the signal decoding process, describing the process of decoding a coded signal:
1. Input signal: Indicates the starting point of the process, where the original encoded signal is received.
2. Signal Data Acquisition: This step involves capturing and digitizing the signal for further analysis. Here, the signal is converted into a form that can be processed digitally.
3. Frequency Separation with a Band-pass Filter: In this step, the signal is filtered to isolate specific frequencies or frequency bands that contain encoded data.
4. Recognition Through Predictive Algorithms of Symbols: Using predictive algorithms, this step of the process identifies and interprets the symbols encoded in the signal. These algorithms can be based on machine learning techniques, pattern recognition, or other artificial intelligence methods.
5. Recognition of Each Symbol: After the initial identification of the symbols, each symbol is analysed individually to determine its exact meaning or value.
6. Reconstruction of the Symbolic Dataset: Once all symbols have been recognized, they are reconstructed into a dataset, reconstructing the original information encoded in the signal.
7. Binary File Regeneration: Finally, the symbolic data is converted into a binary file, completing the decoding process and making the data usable or readable in digital form.

Some preferred embodiments of the present invention have been shown and described previously: obviously, numerous variations and modifications, functionally equivalent to the previous ones, which fall within the scope of the invention as highlighted in the attached claims, will be immediately evident to those skilled in the art. For example, it is clear that data reception can also occur through the use of other operating systems or other graphic interfaces, such as in particular remote controls, customized graphic interfaces, keys and the like.

As regards source coding and data compression for optimizing the storage and transmission of information, the invention in question can also be exploited as a set of digital information processing techniques aimed at compressing information, in particular any type of media or multimedia file, of images, audio and video and digital data, even of an information source that generates them, before saving on a storage medium, allowing a saving on storage space or before a digital transmission allowing a freeing up the necessary bandwidth on the transmission channel at the same transmission speed.

The invention in question therefore allows the reduction of the amount of space necessary for the representation in digital form of the aforementioned information, both to reduce the size of a file, and therefore the space necessary for its storage, and to reduce the occupation of bandwidth required in digital data transmission.

These compression techniques therefore aim to improve the service times for the diffusion of multimedia contents and their transmission in telecommunications networks, as well as to optimize the bandwidth capacity for storing them within the memory supports, organizing them more efficiently in data, compared to the compression standards most used today, in order to obtain a more compact representation of information and therefore involving fewer resources for its storage and transmission.

It is understood that these compression operations are reversible through the reverse source decoding operation, through algorithms created specifically for the implementation of these procedures.

As a practical example, let us consider the following: Multifrequency Communication Smartphone-Smart Devices with MGC Technology and Ultrasonic Relay Configuration:
1. A smartphone is equipped with an application that uses MGC technology to interact with various smart devices, such as smart locks and alarm systems.
2. Signal Transmission: When the user sends a command via an app, the smartphone generates a signal based on Geometric Model Codes (MGC). This ultrasonic signal is transmitted through the smartphone speaker. The transmission uses several frequencies simultaneously. Once transmitted, the sound or ultrasonic signal is received by a microphone installed on the relay.
3. Band-pass Filters in Transmission: During transmission, MGC signals are filtered by band-pass filters, ensuring that each signal remains within its specific frequency band, preventing interference and overlap.
4. Multi-Frequency Reception: The smart device receives MGC signals via its own ultrasound system. Using specific band-pass filters, the device analyses and separates individual frequencies, thus interpreting the various MGC signals received simultaneously.
5. Execution and Feedback: After interpreting the signals, the smart device performs the required actions. It can also send a confirmation signal to the smartphone, following the same multi-frequency communication process.

This example illustrates how MGC technology, combined with multi-frequency ultrasonic transmission and reception and the use of band-pass filters, can create an advanced and reliable communication system between smartphones and smart devices, optimizing safety and efficiency in data transmission.

1) A process for exchanging data/information using sine waves, said process comprising:
coding at least one sine wave to produce at least one coded sine wave
transmitting data using said at least one coded sine wave;
receiving data using said at least one coded sine wave;
wherein said coding of each of said at least one sine wave comprises:
creating a work environment, wherein said creating said work environment comprises:
a. choosing an operating system suitable for project development;
b. installing programming software suitable for a type of project that has to be developed;
c. installing any libraries or frameworks needed for the project;
d. creating an organized folder and file structure to store project files;
adopting a numerical system with a higher base than base 2 of the binary code;
defining and classifying symbols used for the numerical system adopted in a higher base than base 2 through a symbol classification method based on characteristic elements of sine waves;
generating geometric waveforms using mathematical functions;
varying, moment by moment, the amplitude of each sine wave within a Cartesian plane, wherein, time is placed on the abscissa axis and the amplitude of the sine wave is placed on the ordinate axis;
through amplitude modulation, creating points which, in temporal succession and according to pre-established criteria, are crossed by an imaginary line capable of tracing precise geometric shapes, said shapes, combined with each other, generating identifiable signals during the receiving, wherein coded signals representing information to be transmitted, composed of the symbols of the chosen numerical system, said points connected through said imaginary line tracing Coded Geometric Models, MGC, each of which represents a unique symbol in the adopted numerical system, the temporal succession of these said Coded Geometric Models generating identifiable signals during reception as coded signals, the modulation mechanism being formulated through the equation;
MGC×sin(2π ft).
where MGC represents the Coded Geometric Models, each associated with a specific data or value, and the sine function sin(2π ft) describes a periodic wave, in which 2π converts frequency and time into angular phase, t represents the time determining the position within the wave, and f is the frequency of the sine wave, the modulation of an MGC with a sine wave at a specific frequency generating a transmissible and subsequently decodable sound signal in order to recover original data;
creating an array where each symbol is associated with a corresponding numerical value from 0 to n, where n represents, in numerical sequence, the largest value of the array, corresponding in turn to the basis of the numerical system that has to be adopted;
using the array as a type constructor, to allow the definition of new data types starting from pre-existing symbols, in which the combination of the symbols of the array allows communicating information to be transmitted;

2) The process according to claim 1, further comprising: analysing the sound signal.

3) The process according to claim 1, wherein said creating the work environment comprises:
choosing or selecting a high-level, object-oriented programming language to be adopted for application development, scripting, numerical computations and system testing; and
creating a computer library, in which, through the chosen or the selected programming language, said computer library includes high-level mathematical functions and data structures.

4) The process according to claim 1, further comprising: creating a signal composed of the combination of several frequencies and sequencing said sine waves when using a plurality of sine waves with different frequencies.

5) The process according to claim 4, wherein said sequencing sine waves with different frequencies comprises: choosing or selecting the process for determining the exact sequence of the code to be transmitted, the order of the symbols used to represent the signal containing the information to be communicated, wherein, succession on a time scale is used, so that the time line represents, in chronological order, the succession of a series of symbols representing the data to be transferred.

6) The process according to claim 2, wherein the analysing of the received sound signal comprises:
transforming from continuous signal to discrete signal, wherein, for an analysis of a continuous signal received in input, a quantization and conversion technique is used, capable of approximating the continuous signal in a digital string, discrete in time and in amplitude, and, by applying a Fourier Transform, a mathematical operator that allows decomposing a function that varies over time into a discrete set of complex amplitudes at regular time intervals, such as the coefficients of the Fourier series, represented in the domain of frequencies, the spectrum of the function
analysing a signal in the input step, wherein sampling 8 consists in measuring and recording the value of a signal at different moments in time, in order to establish what the minimum sampling frequency is, so that the signal can be reconstructed from the discrete input signal, the Shannon-Nyquist sampling theorem being implemented; and
compiling a source code, wherein, in order to prepare pre-existing multimedia files such as text files, musical pieces, images or videos for transmission from a transmitting electronic device to a receiving electronic device, the source code of the aforementioned files is translated in object code with a base greater than base 2 by a special compiler program.

7) The process according to a claim 1, further comprising: applying an electronic band-pass passive filter, a system or device that carries out functions of transformation or processing of signals placed at an input, the function of the filter being that of eliminating certain frequency bands, letting all frequency bands pass, the MGC signals remaining confined within a chosen frequency band, preventing the encoded geometric shapes from exceeding the established frequency limits.

8) The process according to claim 1, further comprising: encoding information to communicate.

9) The process according to claim 1, further comprising: encrypting information to be communicated.

10) The process according to claim 1, further comprising: encoding information to communicate; and encrypting information to be communicated.
